(19) United States
(12) Patent Application Publication
(10) Pub. No.: US 2026/0096564 A1
(43) Pub. Date: Apr. 9, 2026

(54) FISH BLEEDING TREATMENT METHOD, AND PRODUCTION METHOD FOR BLED FISH

(71) Applicant: Hamasui Co., Ltd., Minamiuwa-gun (JP)

(72) Inventor: Yoshiyuki HAMADA, Minamiuwa-gun (JP)

(21) Appl. No.: 19/416,186

(22) Filed: Dec. 11, 2025

Related U.S. Application Data
(63) Continuation of application No. PCT/JP2024/020452, filed on Jun. 5, 2024.

(30) Foreign Application Priority Data
Jun. 14, 2023 (JP) 2023-097462

(51) Int. Cl. A22B 5/04; G01G 19/52

(52) U.S. Cl. CPC A22B 5/04; G01G 19/52

(57) ABSTRACT

A fish bleeding treatment method includes an insertion step of inserting a tubular instrument, which is a member in a tubular shape, into a circulatory system of a fish; and a gas press injection step of injecting gas for freshness preservation into the circulatory system of the fish through the tubular instrument inserted in the insertion step.

### TECHNICAL FIELD

The present invention relates to a fish bleeding treatment method to maintain the freshness of the fish and a production method for bled fish.

### BACKGROUND

Fish blood is a cause of the fishy smell of fish and one of the causes of deteriorating the freshness of fish. Therefore, removing the blood from a fish body (blood extraction) is a very important task for maintaining the quality of fish.

As a general bleeding treatment method, a method is known in which gills and/or caudal fins are cut and the blood is drained from the blood vessels. However, with this method, blood remains to some degree in the blood vessel system, and it is difficult to remove all the blood.

To address such a problem, for example, Patent Document 1 discloses a method of injecting an injection liquid, which is a liquid containing fine bubbles, into the circulatory system of a fish. This method uses the injection liquid to more reliably remove blood while minimizing damage to the fish's muscle tissue. As a result, this method reduces the fish's odor while preserving its delicious flavor (or UMAMI).

### RELATED ART

### Patent Document(s)

[Patent Document 1] JP Laid-Open Patent Application Publication No. 2023-044743

### Objective to be Solved

However, recently, there has been a demand for not only preventing the fish from spoiling in the light of an organoleptic or microbiological standpoint after fish bleeding treatment, but also for further improvement of the freshness of the fish, particularly in the light of a chemical standpoint. In response to such demands, further improvements are desired beyond conventional methods of injecting liquid containing fine bubbles into the circulatory system of fish.

The present invention has been made in view of the above-mentioned object(s) in the prior art, and one of the objects of the present invention is to further improve the freshness of fish after bleeding treatment.

### SUMMARY

A fish bleeding treatment method of the first invention includes an insertion step of inserting a tubular instrument, which is a member in a tubular shape, into a circulatory system of a fish; and a gas press injection step of injecting gas for freshness preservation into the circulatory system of the fish through the tubular instrument inserted in the insertion step.

With the above configuration, the gas for freshness preservation is injected into every corner (or capillary) of the fish's internal tissues via the fish's blood vessel system, suppressing oxidation of the fish's internal tissues and lowering the K value, which is an objective indicator of the fish's freshness, thereby further increasing the vitality of the fish after bleeding.

The fish bleeding treatment method of the second invention includes an insertion step of inserting a tubular instrument, which is a member in a tubular shape, into a circulatory system of a fish; a liquid press injection step of injecting an injection liquid into the circulatory system of the fish through the tubular instrument inserted in the insertion step; and a gas press injection step of injecting gas for freshness preservation into the circulatory system of the fish through the tubular instrument inserted in the insertion step after the liquid press injection step.

With the above configuration, the blood inside the body is more reliably removed by the injection liquid, and the freshness of the fish is further maintained.

Further, in the fish bleeding treatment method of the third invention, the gas for freshness preservation is hydrogen gas. the gas for freshness preservation is hydrogen gas.

A production method of the fourth invention for a fish of which blood is drained by a fish bleeding treatment, wherein the fish bleeding treatment comprises: an insertion step of inserting a tubular instrument, which is a member in a tubular shape, into a circulatory system of the fish, and a gas press injection step of injecting gas for freshness preservation into the circulatory system of the fish through the tubular instrument inserted in the insertion step.

A production method of the fifth invention for a fish of which blood is drained by a fish bleeding treatment, wherein the fish bleeding treatment comprises: an insertion step of inserting a tubular instrument, which is a member in a tubular shape, into a circulatory system of the fish, a liquid press injection step of injecting an injection liquid into the circulatory system of the fish through the tubular instrument inserted in the insertion step; and a gas press injection step of injecting gas for freshness preservation into the circulatory system of the fish through the tubular instrument inserted in the insertion step after the liquid press injection step.

In the production method of the sixth invention, the gas for freshness preservation is hydrogen gas.

### BRIEF DESCRIPTION OF THE DRAWINGS

FIG. 1 is a flowchart of a fish bleeding treatment method according to a first embodiment of the present invention.

FIG. 2 is a flowchart of a fish bleeding treatment method according to a second embodiment of the present invention.

FIG. 3 is a diagram showing the change characteristics of the K values of Specimens 1 to 3.

FIG. 4 is a photograph showing the condition of Specimens 1 to 4 on the second day after the bleeding treatment.

FIG. 5 is a photograph showing the condition of Specimens 1 to 4 on the fourth day after the bleeding treatment.

FIG. 6 is a photograph showing the condition of Specimens 1 to 4 on the sixth day after the bleeding treatment.

FIG. 7 is a photograph showing the condition of Specimens 1 to 4 on the eighth day after the bleeding treatment.

FIG. 8 is a photograph showing the condition of Specimens 1 to 4 on the tenth day after the bleeding treatment.

### DETAILED DESCRIPTIONS OF THE PREFERRED EMBODIMENT(S)

Hereinafter, embodiments of the present invention are described with reference to the drawings. The embodiments shown below exemplify a fish bleeding treatment method, a fish production method in which the bleeding treatment is applied to a fish (or fish after bleeding treatment) to embody the technical idea/concept of the present invention. The claimed scope of the present invention is not limited to the fish bleeding treatment method, the fish production method after bleeding treatment, the fish after bleeding treatment, and the fish bleeding apparatus. In addition, this specification does not intend to specify the elements recited in the claims as the members of the embodiment(s). The dimensions, materials, shapes, relative arrangements, etc. of the components described in the embodiments are not limited to the claimed elements of the present invention unless otherwise specifically limited. The descriptions in the specification and the drawings are merely illustrative examples of the claimed invention. Note that the sizes and positional relationships of members shown in each drawing may be exaggerated for clarity of explanation.

Furthermore, in the following description, the same names and symbols indicate the same or similar members, and detailed description thereof will be occasionally omitted. Furthermore, two or more of the elements constituting the present invention may be configured with less numbers of elements, or vice versa, so that a single member may serve as a plurality of elements, or a single element may be configured with more than one members A function of one element may be performed with a plurality of elements or also may be realized by sharing several elements.

### FIRST EMBODIMENT

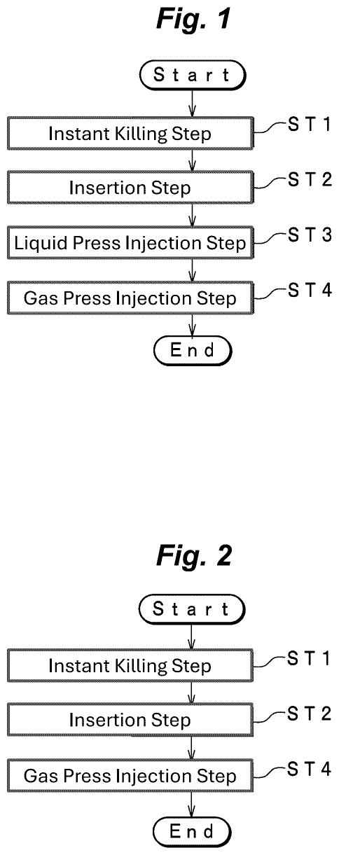

As shown in FIG. 1, the fish bleeding treatment method according to the first embodiment of the present invention mainly comprises an instant killing (Ikejime) step ST1, an insertion step ST2, a liquid press injection step ST3, and a gas press injection step ST4. This fish bleeding treatment method is available to a wide range of fish in general, and is particularly suitable for use with farmed fish such as red sea bream, greater amberjack, yellowtails including small yellowtails, large yellowtails and Japanese amberjack.

In the instant killing step ST1, live fish is killed in a short time so as to minimize its struggles in order to preserve its freshness. To achieve this, a pick is inserted between the eyebrows of the live fish to destroy its brain, or a wire is threaded through its spine to destroy its nerves. In this instant killing step ST1, it is noted that the gills are not removed and the blood vessels at the base of the caudal fin are not cut. Furthermore, even though the live fish is killed instantly, this does not mean that the hearts or internal organs are immediately deprived of its functions. In this bleeding method, it is desirable to complete steps/processes following the instant killing step ST1 as quickly as possible to minimize damage to the heart, internal organs, etc.

In the insertion step ST2, a process is performed to insert a tubular instrument, which is a tubular member, into the circulatory system of the fish. In this embodiment, an injection needle is used as the tubular instrument. This injection needle is inserted from the caudal surface side of the ventricle of the fish's heart toward the bulbus arteriosus. To prevent the needle from coming out after insertion, the part of the bulbus arteriosus through which the injection needle is inserted is pinched with a pinch.

In the liquid press injection step ST3, the injection liquid is injected into the circulatory system of the fish through the injection needle inserted in the insertion step. The injection liquid may be, for example, sterilized seawater or a liquid containing physiological saline as its main component. This injection liquid is pressurized to a predetermined pressure before being supplied to the injection needle so that it can be injected into the circulatory system of the fish.

In this embodiment, in order to suppress the fishy odor regardless of the elapsed time and to enhance Umami flavor (or tasty, rich, savory of fish), the injection liquid may contain fine bubbles. In a case where a liquid mixed with gas such as carbonated water is used for the injection liquid, the process of mixing the gas with the liquid can be omitted when generating the fine bubbles.

Here, fine bubbles are bubbles having a diameter of less than 100 μm, and are standardized by International Organization for Standardization (ISO). Furthermore, among the fine bubbles, bubbles with a diameter of 1 μm or more and less than 100 μm are defined as microbubbles, and bubbles with a diameter of less than 1 μm are defined as ultrafine bubbles. Bubbles generally called nanobubbles (not a term standardized by ISO) belong to the ultrafine bubbles.

The fine bubbles are generated using a known fine bubble generator. The fine bubbles, typically composed of carbon dioxide, are generated over a period of 20 to 60 minutes until saturation is reached with such a known fine bubble generator. When the fine bubbles reach saturation, the concentration of oxygen dissolved in the water is maintained at a constant value. Accordingly, this constant oxygen concentration can be used to determine that fine bubbles have reached saturation. For example, at 15° C., the oxygen concentration in the injection liquid is 5.0 to 6.0 mg/L unless fine bubbles are generated. However, as the amount of fine bubbles generated increases, the oxygen concentration decreases, and even further continuing to generate fine bubbles, the oxygen concentration stops decreasing at 0.05 mg/L. The density of fine bubbles in a saturated state is estimated to be 5.0×10⁸ to 2.0×10⁹ bubbles/mL at temperatures between 0 and 25° C.

The gas that composes the fine bubbles may be air, nitrogen gas, carbon dioxide gas, or a mixture of nitrogen gas and carbon dioxide gas. By ensuring that the fine bubbles do not contain oxygen, it is possible to prevent lipid oxidation in the fish meat and metmyoglobin formation caused by gas components contained in the injection liquid.

The injection fluid injected into the circulatory system of the fish circulates through the body tissues from the aorta, and returns to the heart via the vena cava, and is discharged 1) from the insertion point of the fish's heart, i.e., the gap between the insertion point of the injection needle into the fish's heart and the outer surface of the needle, and/or 2) from weak points of the capillaries in the gills, internal organs, etc. As a result, the blood of the fish is pushed out by the injection fluid and replaced with the injection fluid. Normally, the heart of a fish that has been instant-killed is still functioning at the time when the injection fluid is injected, and the heart's action also promotes the return of the injected injection fluid to the heart.

Whether or not the blood in the fish's body has been replaced with the injection liquid can be determined by the color of the liquid discharged from the insertion point of the fish's heart and/or from weak points of the capillaries in the gills. The color of this discharged liquid is initially red, but the red color gradually fades. When the color of the discharged liquid becomes almost colorless, it is considered that the blood of the fish's body has been replaced with the injection liquid.

In this embodiment, the injection needle is provided in a fish bleeding device (not shown), and the worker operates this fish bleeding device at any time as needed, so that the injection needle can be selectively supplied with the injection liquid and the gas for freshness preservation used in the gas press injection step ST4.

The gas press injection step ST4 is executed after the liquid press injection step ST3. In ST4, the injection needle inserted in the insertion step ST2, i.e., the injection needle used in the liquid press injection step ST3, is not removed from the circulation system, and gas for freshness preservation is injected into the circulatory system of the fish through the injection needle (or the same needle used in ST3).

The gas injected into the circulatory system for freshness preservation is discharged in the same manner as the liquid injected during the liquid press injection step ST3. The injected gas circulates through the fish's body tissues via the aorta, then returns to the heart through the vena cava. It is then discharged: 1) from the insertion point of the fish's heart and/or 2) from weak points of the capillaries in the gills, internal organs, etc. Consequently, the injection fluid introduced into the fish's circulatory system during the liquid press injection step ST3 is discharged with the injected gas for freshness-preservation and replaced with the gas for freshness-preservation.

Whether or not the injection liquid in the liquid press injection step ST3 has been replaced with the gas for freshness preservation is determined by determining whether or not bubbles are coming out from the insertion point of the fish's heart and from weak points of the capillaries in the gills and internal organs.

In this embodiment, the gas used for freshness preservation is hydrogen gas. When an operator operates the above-mentioned fish bleeding device, hydrogen gas pressurized to a predetermined pressure amount is supplied to the injection needle.

Hydrogen gas is cited as an example of a gas for freshness preservation. Any gas possessing an oxidation-inhibiting effect may be used as the gas of the present invention. For example, nitrogen gas, carbon dioxide gas, or mixtures thereof are useful.

### Second Embodiment

As shown in FIG. 2, the fish bleeding treatment method according to the second embodiment of the present invention mainly comprises an instant killing step ST1, an insertion step ST2, and a gas press injection step ST4. That is, the fish bleeding treatment method according to the second embodiment of the present invention omits the liquid press injection step ST3 shown in FIG. 1. In the second embodiment, immediately after the insertion step ST2, gas for freshness preservation is injected into the circulatory system of the fish through the tubular instrument inserted in the insertion step ST2. This step differs from the first embodiment of the present invention. The gas for freshness preservation injected in the gas press injection step ST4 pushes blood and other substances from the insertion point of the fish's heart, and/or from weak points of the capillaries in the gills, internal organs, etc. The gas for freshness preservation then leaks out from the insertion point of the fish's heart and/or from the weak points of the capillaries in the gills, internal organs, etc. When bubbles are confirmed to emerge from the insertion point of the fish's heart, and/or from the gills, and internal organs, etc., it is determined that the blood in the blood vessels has been replaced with gas for freshness preservation.

### Example

Next, an example of a fish bleeding treatment method according to the present invention will be described.

In order to verify the effectiveness of the present invention, four live yellowtails weighing approximately 5 kilograms (error range: plus or minus 0.1 kilograms) were taken out of a curing pen, and these four yellowtails were designated as Specimens 1 to 4.

As Example 1, a bled fish was produced from Specimen 1 using the fish bleeding treatment method according to the first embodiment of the present invention shown in FIG. 1.

In the liquid press injection step ST3, sterilized seawater was used as the injection liquid. This injection liquid was pressurized to a pressure of 0.1 MPa and supplied to the injection needle inserted into the fish for 8 minutes. During this period, the amount of pressurized liquid supplied to the injection needle reached approximately 4 liters. It was then confirmed that the color of the liquid discharged from the injection point of the fish's heart and from the weak points of the capillaries in the gills became almost colorless. At this time, the color of the gills also changed from red to whitish.

In the gas press injection step ST4, hydrogen gas at a pressure of 0.2 MPa was supplied to the injection needle as the gas for freshness preservation for 4 minutes. As a result, it was confirmed that the injection liquid in the fish's body was replaced with hydrogen gas.

As Comparative Example 1, Specimen 2 was subjected to the instant killing step ST1, insertion step ST2 and liquid press injection step ST3 shown in FIG. 1 to produce a bled fish without carrying out the gas press injection step ST4. As Comparative Example 2, Specimen 3 was subjected to only the instant killing step ST1 shown in FIG. 1 to produce another bled fish.

Furthermore, As Example 2, another bled fish was produced from Specimen 4 using the fish bleeding treatment method according to the second embodiment of the present invention shown in FIG. 2. In the gas press injection step ST4 shown in FIG. 2, immediately after inserting the injection needle to piercing Specimen 4, hydrogen gas at a pressure of 0.2 MPa was supplied to the injection needle as the gas for freshness preservation for 4 minutes in the same manner as in Example 1. It was then confirmed that bubbles were coming out from the insertion point of the fish's heart, the gills, and the internal organs etc.

In gas press injection step ST4, the hydrogen gas pressure at which the gas is supplied into the fish and the gas supply time during which the gas is supplied may be adjusted according to the fish weight. For example, for a yellowtail weighing approximately 5 kilograms, the hydrogen gas for freshness preservation is supplied at 0.2 MPa for 4 minutes. For a yellowtail weighing approximately 6 kilograms, it is supplied at 0.2 MPa for 5 minutes. For sea bream weighing approximately 2 kilograms, the hydrogen gas is supplied at 0.1 MPa for 4 minutes. For sea bream weighing 1 kilogram, the hydrogen gas is supplied at 0.05 MPa for 4 minutes. As described above, for fish weighing 1 to 5 kilograms, the supply time is maintained constant (4 minutes) and the supply pressure of the hydrogen gas for freshness preservation vary within the range of 0.05 to 0.2 MPa depending on the fish weight. For fish weighing over 5 kilograms, the supply pressure of the hydrogen gas is set to 0.2 MPa, and the supply time increases. Note that, for fish weighing less than 1 kilogram, the gas treatment may not be processed. The gas supply time may be defined as a supply time or supply period

In the process of the present invention, the upper limit of the gas supply pressure may be determined according to the type of fish that is processed. This is because pressures exceeding an appropriate upper limit may increase the risk of damaging the fish cells. For the above yellowtail and the sea bream, the gas supply may be limited to approximately 0.2 MPa. These relationships are summarized in Additional Table below.

[Additional Table]

| | Supply Pressure | Supply Time |
|---|---|---|
| Sea Bream (1 kg) | 0.05 MPa | 4 min |
| Sea Bream (2 kg) | 0.1 MPa | 4 min |
| Yellowfin (5 kg) | 0.2 MPa | 4 min |
| Yellowfin (6 kg) | 0.2 MPa | 5 min |

Fish Weight (less than 1 kg): No process
Fish Weight (1 kg to 5 kg): Supply pressure from 0.05 to 0.2 MPa
Fish Weight (more than 5 kg): Supply time vary with consistent supply pressure (0.2 MPa)

When implementing the present invention, the supply pressure and the supply period may be set according to the weight of the processed fish. In the example described above, the upper weight threshold is 5 kg, and the lower weight threshold is 1 kg. The upper weight threshold may be determined considering the value of the supply pressure of gas and may be approximately five times the lower weight threshold, or it may be smaller or larger than that.

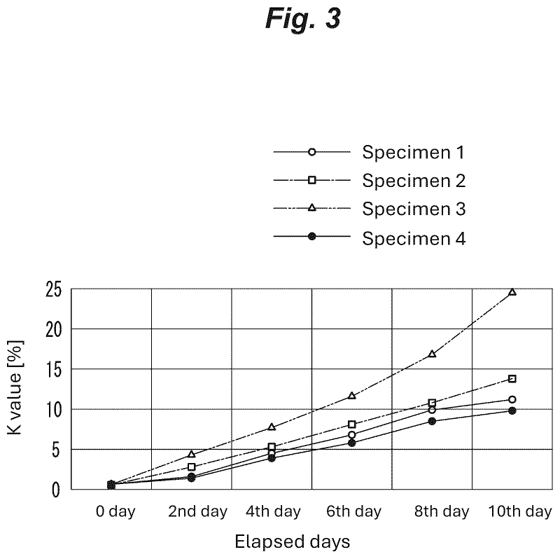

Next, each of the bled fish Specimens 1 to 4 was cooled until their core temperature reached approximately 5° C. The specimens were then cooked into sashimi. The sashimi Specimens 1 to 4 were then stored in cold air at 5° C. for 10 days. Additionally, to objectively assess the viability of the specimens from a chemical perspective, the K values of the sashimi Specimens 1 to 3 were calculated every two days during the 10-day storage period using high-performance liquid chromatography. The results are shown in Table 1 and FIG. 3. In FIG. 3, the horizontal axis corresponds to the number of elapsed days, and the vertical axis corresponds to the K value.

TABLE 1

| | | Elapsed days - K value [%] | | | | | |
|---|---|---|---|---|---|---|---|
| Treatment | Specimen | 0 day | 2nd day | 4th day | 6th day | 8th day | 10th day |
| Example 1 | Specimen1 | 0.64 | 1.6 | 4.5 | 6.8 | 9.9 | 11.2 |
| Example 2 | Specimen4 | 0.65 | 1.4 | 3.9 | 5.8 | 8.5 | 9.8 |
| Comparative | Specimen2 | 0.61 | 2.8 | 5.3 | 8.1 | 10.8 | 13.8 |
| Example 1 | | | | | | | |
| Comparative | Specimen3 | 0.62 | 4.3 | 7.7 | 11.6 | 16.8 | 24.5 |
| Example 2 | | | | | | | |

The guideline for determining whether or not raw fish such as yellowtail sashimi is safe for consumption is said that the K-value of the fish is 20% or lower. Furthermore, for example, assuming delivery within Japan for blood bred fish, a transport period of 10 days is considered sufficient. As shown in FIG. 3, the K-values on the 10th day for Specimen 1 of Example 1, Specimen 4 of Example 2, and Specimen 2 in Comparative Example 1 were all below 20%. Therefore, Specimens 1, 4, and 2 remained suitable for raw consumption even after 10 days. In contrast, the K-value on the 10th day for Specimen 3 in Comparative Example 2 exceeded 20%. Thus, it was demonstrated that Specimen 2 was unsuitable for raw consumption after 10 days. Furthermore, the K-values on day 10 for Specimen 1 of Example 1 and Specimen 4 of Example 2 were lower than the K-value on day 10 for Specimen 2 in Comparative Example 1. This indicates that the fish bleeding treatment method of the present invention further enhances the vitality of fish after the bleeding treatment compared to the treatment in Comparative Example 1.

To promote the consumption of fish that can be eaten raw, it is important to understand the viability of the fish after the bleeding treatment not only objectively from a chemical perspective but also from a sensory perspective. Therefore, for sashimi Specimens 1 to 4, sensory tests were conducted every two days during the 10-day storage period, regarding K value, as well as firmness, color, Umami, texture, odor, and drip.

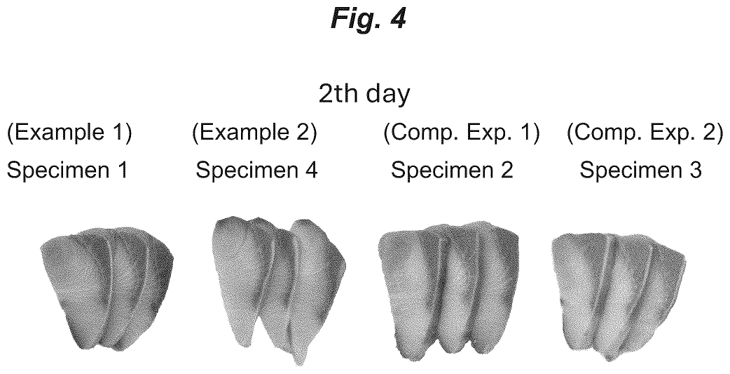

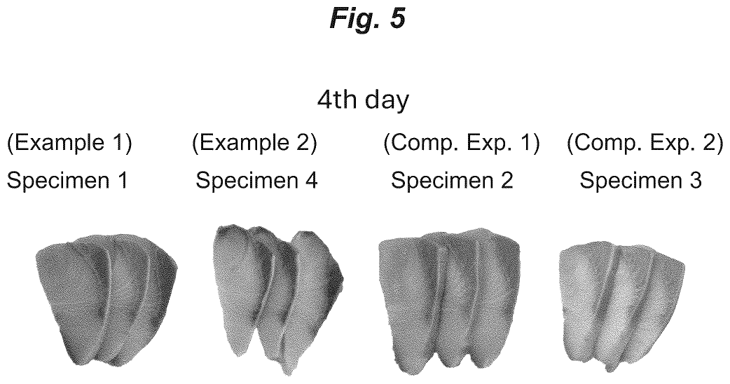

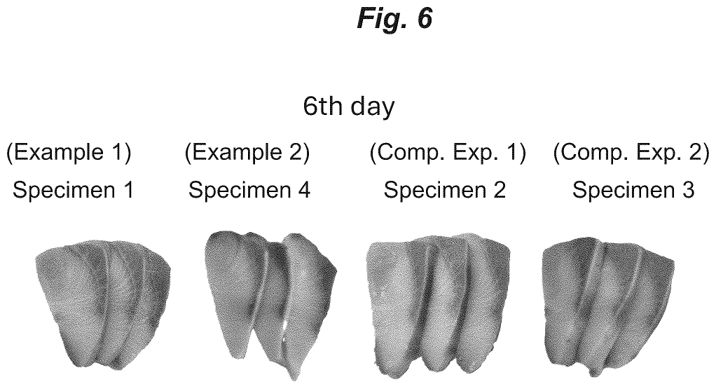

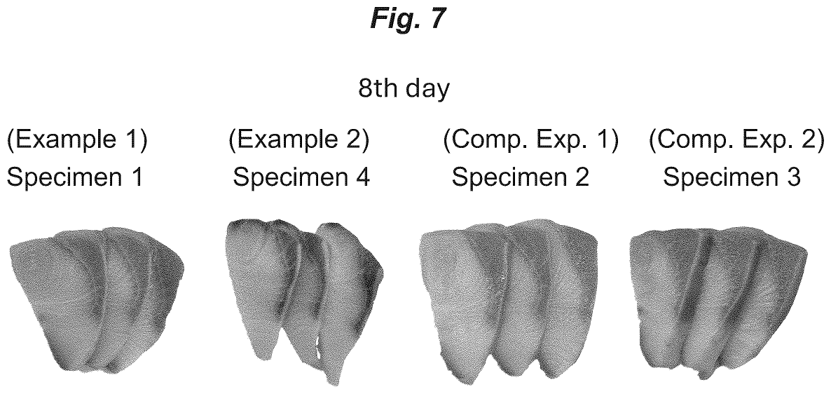

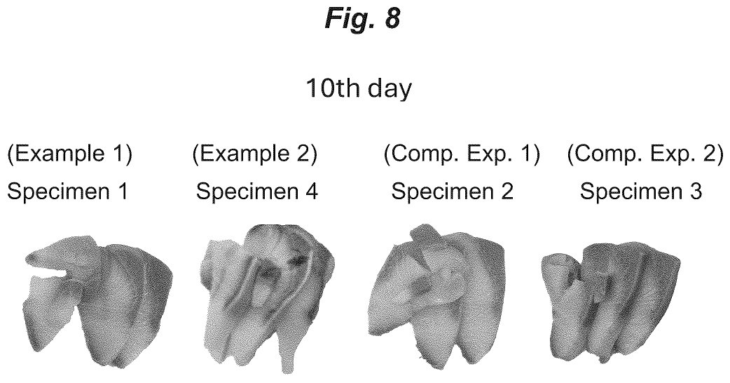

The sensory test for meat quality evaluates the meat quality such as the firmness of the sashimi by touch, and in some cases visually. The sensory test for color evaluates visually the discoloration of the sashimi. The sensory test for Umami evaluates the Umami of the sashimi by taste. The sensory test for texture evaluates the sensation experienced when placing food in the mouth, such as its chewiness and texture on the tongue. The sensory test for odor evaluates olfactory the odor of the sashimi. The sensory test for drip evaluates visually the presence or absence of meat juice flowing from the sashimi. In these sensory tests, each evaluation item was rated on a five-point scale. The lowest rating was assigned “1” and the highest rating “5.” The evaluation scores for each evaluation item for Specimens 1 to 4 were then added together to show the total score. The results of these sensory tests are shown in Table 2. FIGS. 4 to 8 show the changes in appearance of Specimens 1 to 4 used in the sensory tests.

TABLE 2

| E. days | Treatment | Spn. | Firmness | Color | Umami | Texture | Odor | Drip | Total |
|---|---|---|---|---|---|---|---|---|---|
| 2nd | Example 1 | Spn. 1 | 5 | 5 | 5 | 5 | 5 | 5 | 30 |
| day | Example 2 | Spn. 4 | 5 | 5 | 5 | 5 | 5 | 5 | 30 |
| | C.E. 1 | Spn. 2 | 5 | 5 | 5 | 5 | 5 | 5 | 30 |
| | C.E. 2 | Spn. 3 | 4 | 4 | 4 | 4 | 3 | 4 | 23 |
| 4th | Example 1 | Spn. 1 | 5 | 5 | 5 | 5 | 5 | 5 | 30 |
| day | Example 2 | Spn. 4 | 5 | 5 | 5 | 5 | 5 | 5 | 30 |
| | C.E. 1 | Spn. 2 | 5 | 5 | 5 | 5 | 5 | 5 | 30 |
| | C.E. 2 | Spn. 3 | 3 | 3 | 3 | 3 | 2 | 3 | 17 |
| 6th | Example 1 | Spn. 1 | 5 | 5 | 5 | 5 | 5 | 5 | 30 |
| day | Example 2 | Spn. 4 | 5 | 5 | 5 | 5 | 5 | 5 | 30 |
| | C.E. 1 | Spn. 2 | 4 | 5 | 5 | 4 | 5 | 5 | 28 |
| | C.E. 2 | Spn. 3 | 2 | 2 | 3 | 2 | 2 | 2 | 13 |
| 8th | Example 1 | Spn. 1 | 5 | 4 | 5 | 5 | 4 | 5 | 28 |
| day | Example 2 | Spn. 4 | 5 | 4 | 5 | 5 | 4 | 5 | 28 |
| | C.E. 1 | Spn. 2 | 4 | 4 | 4 | 4 | 4 | 4 | 24 |
| | C.E. 2 | Spn. 3 | 1 | 1 | 2 | 1 | 1 | 1 | 7 |
| 10th | Example 1 | Spn. 1 | 4 | 3 | 4 | 4 | 4 | 4 | 23 |
| day | Example 2 | Spn. 4 | 4 | 3 | 4 | 4 | 4 | 4 | 23 |
| | C.E. 1 | Spn. 2 | 3 | 3 | 3 | 3 | 4 | 4 | 20 |
| | C.E. 2 | Spn. 3 | 1 | 1 | 1 | 1 | 1 | 1 | 6 |

E. days: Elapsed days
C.E. 1: Comparative Example 1
C.E. 2: Comparative Example 2
Spn.: Specimen
Spn. 1 to 4: Specimen 1 to 4

As shown in Table 2, the total scores of the test items for Specimen 1 of Example 1 and Specimen 4 of Example 2 changed similarly with the number of elapsed days. From the sixth day and later, both of the total scores were greater than the total score of the test items for Specimen 2 in Comparative Example 1. Therefore, the fish bleeding treatment method of the present invention was proved to have the effect of further improving the freshness of the fish after bleeding treatment not only from a chemical standpoint but also from a sensory standpoint

### LEGENDS

ST1: Instant killing step
ST2 . . . . Insertion step
ST3: Liquid press injection step
ST4: Gas press injection step

What is claimed is:

1. A fish bleeding treatment method, comprising:
an insertion step of inserting a tubular instrument, which is a member in a tubular shape, into a circulatory system of a fish; and
a gas press injection step of injecting gas for freshness preservation into the circulatory system of the fish through the tubular instrument inserted in the insertion step.

2. The fish bleeding treatment method, comprising:
an insertion step of inserting a tubular instrument, which is a member in a tubular shape, into a circulatory system of a fish;
a liquid press injection step of injecting an injection liquid into the circulatory system of the fish through the tubular instrument inserted in the insertion step; and
a gas press injection step of injecting gas for freshness preservation into the circulatory system of the fish through the tubular instrument inserted in the insertion step after the liquid press injection step.

3. The fish bleeding treatment method according to claim 1, wherein
the gas for freshness preservation is hydrogen gas.

4. The fish bleeding treatment method according to claim 2, wherein
the gas for freshness preservation is hydrogen gas.

5. The fish bleeding treatment method according to claim 1, wherein
the injecting gas used in the gas press injection step is supplied at a supply pressure that ranges from 0.05 to 0.2 MPa into the circulatory system of the fish.

6. The fish bleeding treatment method according to claim 1, further comprising:
a measuring step of measuring a weight of the fish, wherein
when the weight of the fish that is measured in the measuring step is equal to or less than a predetermined upper weight threshold, the injecting gas used in the gas press injection step is supplied into the circulatory system of the fish
at a supply pressure that ranges from 0.05 to 0.2 MPa, and
for a supply period that is set consistent regardless of the weight of the fish.

7. The fish bleeding treatment method according to claim 2, further comprising:
a measuring step of measuring a weight of the fish, wherein
when the weight of the fish that is measured in the measuring step is equal to or less than a predetermined upper weight threshold, the injecting gas used in the gas press injection step is supplied into the circulatory system of the fish
at a supply pressure that ranges from 0.05 to 0.2 MPa, and
for a supply period that is set consistent regardless of the weight of the fish.

8. The fish bleeding treatment method according to claim 1, further comprising:
a measuring step of measuring a weight of the fish, wherein
when the weight of the fish that is measured in the measuring step is more than a predetermined upper weight threshold, the injecting gas used in the gas press injection step is supplied into the circulatory system of the fish
at a supply pressure that is set at approximately 0.2 MPa, and
for a supply period that is set longer than a supply period that is set for the fish of which weight is equal to or less than the predetermined upper weight threshold.

9. The fish bleeding treatment method according to claim 6, wherein
when the weight of the fish that is measured in the measuring step is more than the predetermined upper weight threshold, the injecting gas used in the gas press injection step is supplied into the circulatory system of the fish
at a supply pressure that is set at approximately 0.2 MPa, and
for a supply period that is set longer than the supply period that is set for the fish of which weight is equal to or less than the predetermined upper weight threshold.

10. The fish bleeding treatment method according to claim 9, wherein
when the weight of the fish that is measured in the measuring step is less than a predetermined lower weight threshold, the gas press injection step is not performed for the fish.

11. The fish bleeding treatment method according to claim 10, wherein
the upper weight threshold of the fish is approximately 5 kg, and
the lower weight threshold of the fish is approximately 1 kg.

12. The fish bleeding treatment method according to claim 10, wherein
the upper weight threshold of the fish is five times or more the lower weight threshold of the fish.

13. A production method for a fish of which blood is drained by a fish bleeding treatment, wherein
the fish bleeding treatment comprises:
an insertion step of inserting a tubular instrument, which is a member in a tubular shape, into a circulatory system of the fish, and
a gas press injection step of injecting gas for freshness preservation into the circulatory system of the fish through the tubular instrument inserted in the insertion step.

14. A production method for a fish of which blood is drained by a fish bleeding treatment, wherein
the fish bleeding treatment comprises:
an insertion step of inserting a tubular instrument, which is a member in a tubular shape, into a circulatory system of the fish,
a liquid press injection step of injecting an injection liquid into the circulatory system of the fish through the tubular instrument inserted in the insertion step; and
a gas press injection step of injecting gas for freshness preservation into the circulatory system of the fish through the tubular instrument inserted in the insertion step after the liquid press injection step.

15. The production method according to claim 13, wherein
the gas for freshness preservation is hydrogen gas.

16. The production method according to claim 14, wherein
the gas for freshness preservation is hydrogen gas.

17. The production method according to claim 13, further comprising:
a measuring step of measuring a weight of the fish, wherein
when the weight of the fish that is measured in the measuring step is equal to or less than a predetermined upper weight threshold, the injecting gas used in the gas press injection step is supplied into the circulatory system of the fish
at a supply pressure that ranges from 0.05 to 0.2 MPa, and
for a supply period that is set consistent regardless of the weight of the fish.

18. The production method according to claim 14, further comprising:
a measuring step of measuring a weight of the fish, wherein
when the weight of the fish that is measured in the measuring step is equal to or less than a predetermined upper weight threshold, the injecting gas used in the gas press injection step is supplied into the circulatory system of the fish
at a supply pressure that ranges from 0.05 to 0.2 MPa, and
for a supply period that is set consistent regardless of the weight of the fish.

19. The production method according to claim 13, further comprising:
a measuring step of measuring a weight of the fish, wherein
when the weight of the fish that is measured in the measuring step is more than a predetermined upper weight threshold, the injecting gas used in the gas press injection step is supplied into the circulatory system of the fish
at a supply pressure that is set at approximately 0.2 MPa, and
for a supply period that is set longer than a supply period that is set for the fish of which weight is less than the predetermined upper weight threshold.

20. The production method according to claim 14, further comprising:
a measuring step of measuring a weight of the fish, wherein
when the weight of the fish that is measured in the measuring step is more than a predetermined upper weight threshold, the injecting gas used in the gas press injection step is supplied into the circulatory system of the fish
at a supply pressure that is set at approximately 0.2 MPa, and
for a supply period that is set longer than a supply period that is set for the fish of which weight is less than the predetermined upper weight threshold.
